(19) United States
(12) Patent Application Publication
(10) Pub. No.: US 2013/0193597 A1
(43) Pub. Date: Aug. 1, 2013

(54) REFLECTOR MOLDING APPARATUSES AND METHODS THEREOF

(71) Applicants: Zhu Qing Jin, Xiamen (CN); James X. Jing, Hartsville, PA (US); Chang Kuo-An, Taipei (CN); Chai Wan Min, Xiamen (CN)

(72) Inventors: Zhu Qing Jin, Xiamen (CN); James X. Jing, Hartsville, PA (US); Chang Kuo-An, Taipei (CN); Chai Wan Min, Xiamen (CN)

(73) Assignee: REFLEXITE CORPORATION, Avon, CT (US)

(21) Appl. No.: 13/363,921

(22) Filed: Feb. 1, 2012

(51) Int. Cl. B28B 11/08; B29D 11/00

(52) U.S. Cl. 264/2.1; 425/322

(57) ABSTRACT

A reflector molding apparatus includes two pressure rollers with pressure surfaces of the rollers comprising convex teeth and concave teeth in mesh. The reflection film is put on the aluminum sheet as the unmolded material. The unmolded material goes to the pressure surfaces in mesh and is molded to be a reflector. The surface of the resulting reflector is corrugated shaped because of the pressure of the rollers. The shape of the reflector changes with the pressure surface of the rollers.

### FIELD

This technology generally relates to molding apparatuses and methods and, more particularly, to reflector molding apparatuses and methods thereof.

### BACKGROUND

A reflection film, or a reflex reflection film, can reflex reflect incident light to the film along an incident direction. Light from different directions will be reflected by the film surface due to the property of reflection. The film can be utilized in a variety of different applications, such as travel signs, car plates, notices, and billboards. The film also can be put on a board to form a reflector with a different shape.

The wide-angle property or reflection of the reflective film can vary from one film to another. Because the film is put on different shapes of the boards, the surface and the incident angle affect a lot of the reflection of the reflector. For example, when a reflector, which is formed from a reflective film which has a higher reflectance at a low-angle of incidence, is illuminated at a wide-angle of incidence, the effect of the reflection will greatly abate because the wide-angle property of the film is weak.

There are some solutions. For example, applying a wide-angle incidence stamp to the reflector to generate rhombic-shaped raisings makes the reflector having some reflectance because the raisings reflect the incident light. Unfortunately, stamping or molding by this reflector is accomplished at a slow speed and, although the reflectance of the raising helps, it is still limited. Accordingly, existing methods can not provide the needed or desired reflectance of the reflector.

### SUMMARY

One example of this technology relates to a reflector molding apparatus and a molding method that overcomes the above-noted problems of the prior art. This technology can easily and flexibly mold reflective film to form different types of reflectors. For example, with this technology molded reflectors can be easily produced that overcome the problem of low reflectance at wide-angle incidences and can be designed to provide full reflection. Further, this technology can make customized reflectors quickly and inexpensively compared to the prior art.

### BRIEF DESCRIPTION OF THE DRAWINGS

FIG. 1 is a side view of an exemplary reflector molding apparatus;

FIG. 2 is a side view illustrating greater detail of pressure applied by the exemplary pressure rollers;

FIG. 3 illustrates another side view of the exemplary reflector molding apparatus.

### DETAILED DESCRIPTION

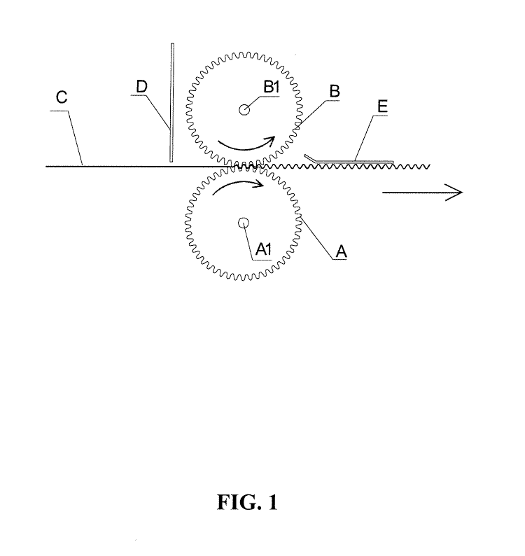

Referring to FIGS. 1-3, an example of the reflector molding apparatus includes two press rollers (A, B) to mold the reflector is illustrated The press surface of each roller comprises convex teeth and concave teeth in meshing engagement, although other types and numbers of teeth in other arrangements could be used The engagement region is located where the press rollers detachably mesh with each other in operation. The degree of the detachable engagement between the press rollers is adjustable.

An example of the method for molding with the reflector molding apparatus comprises:

The unmolded material C goes into the engagement region of the pressure surfaces of the rollers (A, B) along the gap between the protective board D and the working face. The unmolded material C is pressed by the convex teeth and the concave teeth in a detachable meshing engagement on the pressure surface. The unmolded material is shaped into the molded material F and goes away from the engagement region along the tangential direction.

According to the travel direction of unmolded material, a protective board D is disposed in the front of the two cylinder rollers (A, B) and above the pressure surface to protect the engagement region and limit the input of the unmolded material C.

A leading sheet E is disposed in the backward of the molded material F, making the travel of the molded material F in steady direction.

This exemplary technology has the following effects:

The resulting surface of the reflector generated by meshed teeth of the molding apparatus is not flat, but has a corrugated shaped because of the pressure of the rollers.

The incident light from one direction will change into a different angle of incidence on the reflective film. With this exemplary technology, an exemplary reflective film which provides good reflectance at a wide-angle incidence can be easily and inexpensively produced. This exemplary technology also raises the utilization rate and the efficiency of the reflective film.

According to the particular needs and applications, the convex teeth and the concave teeth on the pressure rollers can be designed to have different shapes, so that the sharpness on the reflector surface can be adjusted.

Examples of this technology will be described in more detail below with reference to the drawings.

Referring more specifically to FIG. 1, an example of this technology is illustrated. The exemplary apparatus includes two pressure rollers (A, B), the sides of the two cylinder serve as the pressure surfaces. The two rollers (A, B) comprise convex teeth and concave teeth of same specification in meshing engagement respectively, although the teeth could have other configurations and dimensions. The convex teeth and the concave teeth on the rollers also can be designed to have different shapes, so that the sharpness on the reflector surface varies.

The roller A is driven by a motor and rotates with the roller B which is driven by the coupled driving engagement of the two rollers. The rollers (A, B) are fixed on the working face and the distance between the rotating axes (A1, B1) is adjustable, but is set during working operation.

The reflex reflection film is put above the aluminum sheet as the unmolded material C. The unmolded material C goes through the crack under the protective board D, inserts to the engagement region of the rollers (A, B), is pressed by the detachable engagement or meshing of the rollers (A, B), and is output through the leading sheet E. The result is the molded reflector F with a corrugated shape.

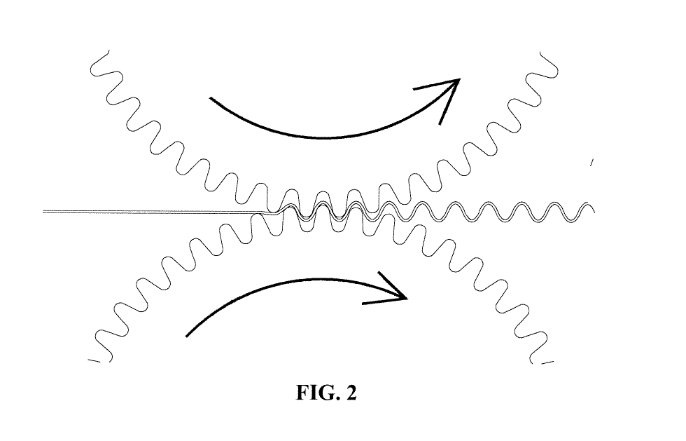

Referring to FIG. 2, a more detailed illustration of the engagement of the rollers (A, B) pressing a reflector is provided.

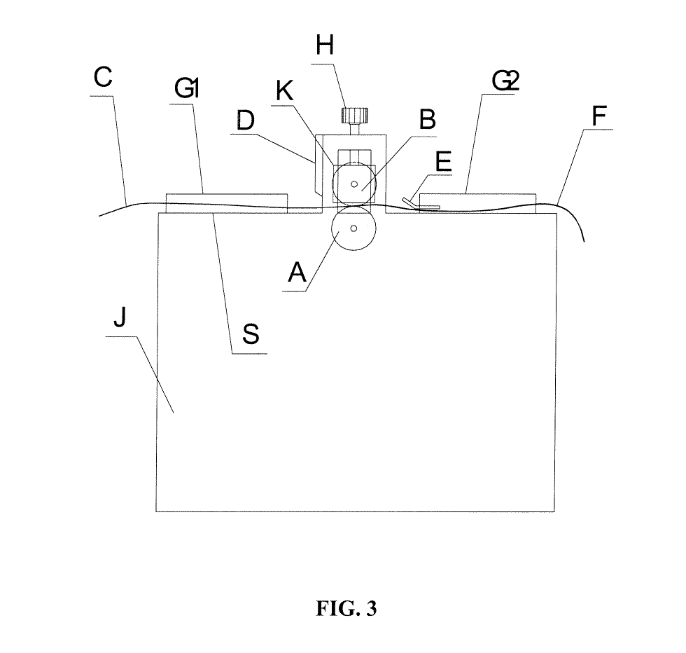

Referring to FIG. 3 a side view of the exemplary embodiment is illustrated. According to the drawing, the power, drive and control system J provides power to the molding apparatus as well as the necessary controls to drive this apparatus. Since power, drive and control systems, such as a motor, belt, gear decelerator, switch and leads, alone or in combination, are well known to those of ordinary skill in the art they will not be described in detail here. The power, drive and control system J also serves as a working face S as well in this example.

The rollers (A, B) arrange vertically on the working face S up and down, and the sides thereof form the pressure surfaces. The engagement region of the rollers (A, B) is slightly higher than the working face S.

The roller A is arranged down, driven by the power, drive and control system in J. The roller B is arranged above the roller A, and the ends of the rotating axis are fixed to the slide K. The slide K will move vertically with the control of the screw handle H and adjust the distance between the rollers (A, B) so that the unmolded material C will be molded properly with a good surface and the film will not be damaged. The rollers can be changed to have a variety of different types of meshing surfaces when necessary, and it is convenient to change the rollers to meet other standards or requirements for the reflector being produced

Limiters (G1, G2) are formed from a cover with two wings or a metal rod. The limiters (G1, G2) are used to keep the unmolded material C and the molded material F in motion.

The unmolded material will be pressure molded after power is applied to drive the pressure rollers to rotate and detachably mesh by the power, drive and control system in J.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A reflector molding apparatus comprising two press rollers positioned to detachably mesh to mold a reflector, a pressure surface of each of the rollers comprises at least one of convex teeth and concave teeth.

2. The apparatus according to the claim 1, wherein the convex teeth and concave teeth on the pressure surfaces of the rollers have a corrugated shape.

3. The apparatus according to the claim 1, wherein a distance between rotation axes of the rollers is adjustable.

4. The apparatus according to the claim 3, wherein a protective board is disposed in a forward engagement region of the two rollers.

5. The apparatus according to the claim 4, wherein a leading sheet is disposed in a backward engagement region of the two rollers.

6. A method comprising:
fixing a distance between rotation axes of press rollers;
revolving each of the press rollers around a different rotating axis, the press rollers positioned to detachably mesh together;
inputting unmolded material along an engagement region of the press rollers;
pressing the unmolded material between the detachably meshed press rollers; and
outputting the pressed material along a velocity direction of the press rollers.

7. The method of claim 6 further comprising disposing a protective board is disposed in the front of the press rollers at a position to limit the unmolded material.

8. The method of claim 7 further comprising disposing a leading sheet is disposed in back of the press roller rollers at a position to limit the output direction of the molded material.
